(19) United States
(12) Patent Application Publication
(10) Pub. No.: US 2005/0215321 A1
(43) Pub. Date: Sep. 29, 2005

(54) Video game controller with integrated trackball control device

(76) Inventors: Saied Hussaini, Miami, FL (US); Marc Iacovelli, Miami, FL (US)

Correspondence Address: LINIAK, BERENATO & WHITE, Suite 240, 6550 Rock Spring Drive, Bethesda, MD, 20817, US

(21) Appl. No.: 10/963,741

(22) Filed: Oct. 14, 2004

Related U.S. Application Data
(60) Provisional application No. 60/556,874, filed on Mar. 29, 2004.

(51) Int. Cl. A63F 13/00

(52) U.S. Cl. 463/37

(57) ABSTRACT

A hand-held video game controller for interaction with a computer gaming unit. The video game controller comprises a hollow casing defining a central control section, and left and right hand grip sections extending from the control section. The control section includes a plurality of switches which a user will utilize to enter data and control signals. Those switches are intended to be individually operated by one or both thumbs of the user. The video game controller further includes at least one trackball input device integrally mounted to the control section of the casing for manipulation by the user for producing a game input signal indicative to the amount and direction of rotational movement of a trackball relative to the casing in each of orthogonal directions. The game controller also includes at least one joystick integrally mounted to the control section of the casing for manipulation by the user.

### CROSS-REFERENCE TO RELATED APPLICATION

This Application claims the benefit under 35 U.S.C. 119(e) of U.S. Provisional Application No. 60/556,874 filed Mar. 29, 2003 by Hussaini, S. et al. and is incorporated herein by reference.

### BACKGROUND OF THE INVENTION

1. Field of the invention

The present invention relates to hand-held video game controllers in general, and more specifically to a hand-held video game controller with integrated trackball-type control member having selective programmable features.

2. Description of the Related Art

Computer video games are well known in the art. Such devices range from small hand-held all-in-one units, to larger stand-alone units which interact with stand-alone controllers. For more sophisticated play, stand-alone computer units provide tremendous processing power and work with associated peripheral devices, such as a remote controller and television display in an attempt to bring the player a more dramatic gaming experience to that of hand-held devices. A central stand-alone console contains all the essential processing components to run a computer game. A controller is connected to communicate operation control commands from a user. As previously mentioned, this conventional arrangement is well known in the art.

With the tremendous commercial success of stand-alone computer gaming systems, an entire peripheral market has emerged ranging from advanced video controllers, joystick input devices, steering wheel devices for racing games, multi-tap controllers, vibrating controllers, video stands, audio systems and the like. Programmable controllers are also available which allow a user to customize the operation of control buttons by programming different modes of operation.

Track balls have been employed in such devices as lap tops computers and other electronic devices. In such devices, such as laptop, a control ball is rotatably mounted into the surface of the console and optical sensors sense the movement of the ball. Such prior art devices have been employed to control the simple movement of a cursor on the lap top display screen. However, the prior art is void of a hand held control unit incorporating a track ball control member or the use of a track ball control member to in a personal video gaming platform. The present invention includes several embodiments for various implementation of a track ball to control a video game in a hand held controller.

FIGS. 1A and 1B represent a prior art hand held controller including a conventional directional pad, a pair of stick control members and four control buttons. The directional pad is limited to finite control in four directions. More specifically, the video game controller 10 of the prior art includes a plurality of buttons 14, a multi-directional switch 16, commonly known as D-pad (Directional pad), joystick input devices 18a and 18b, and triggers (shoulder buttons) 20. D-pads are well known in the game controller art, and function to provide particular contact closures depending upon where the user applies pressure on an operating button thereof. When the user depresses the uppermost or northern position of the D-pad, such is equivalent to depressing a key of a standard keyboard. When the user depresses the rightmost or east portion of the D-pad, such is equivalent to a different key of a standard keyboard being depressed. Likewise, separate keystroke entries are made by depressing the southern portion and western portion. It is possible to provide for yet additional keystroke entries by depression of the D-pad in portions intermediate the north, east, south and west positions without departing from the scope of the present invention.

The video game controller 10 has various buttons to implement several modes of operation. The video game controller 10 and the computer gaming unit contain circuitry and drivers to effectuate the commands given from a user to the computer gaming unit via the video game controller 10. For example, a start button 24 is used to start a video game once the computer gaming unit is turned on. Usually an opening screen appears to the operator on a display device. Another example of a button with specific functions is the select button 28.

Often times, each button 14, joystick input device 18a or 18b, trigger (shoulder button) 20 has a particular command in which it executes. For example, if a user is playing a hockey game loaded on the computer gaming unit, D-pad 16 would control the movement of the player under the control of the video game controller 10. The other players would be controlled by an additional user through another video game controller or by the computer gaming unit itself. When the user presses upon the button 14 with the square, the player on the display would pass the hockey puck to another player, while if the user presses the button 14 with the triangle, the player to shoot the puck towards the goal. Similarly, the right trigger 20 may allow the player under the control of the video game unit to check, or hit, another player on the screen. Or the button 14 with the circle allows a player to accelerate and move faster than normal. Thus, each button 14, trigger 20, pad 16 and joystick input devices 18a, 18b has a distinct function assigned to it.

Many games allow a user to select a “turbo” mode for a particular function. It is often desirable to have a particular function at an accelerated speed or provide an additional power boost to the action on the display. Thus, a user will effectuate the “turbo” or program mode through activation of the “turbo” button 30. For example, when the hockey player in the above example is skating and the user wishes to activate the “turbo” function, he might hold down button 14 with the circle on the top while simultaneously pressing the “turbo” button 30. This would essentially place the circle button 14 in “turbo” or program mode. When circle button 14 is in “turbo” mode the player may skate faster than if circle button 14 was pressed while not in “turbo” or program mode. Thus, a particular button may be selectively programmed in either normal or “turbo” modes.

While known hand-held video game controllers, including but not limited to those discussed above, have proven to be acceptable, such devices are nevertheless susceptible to improvements that may enhance their performance and ease and convenience of use. With this in mind, a need exists to develop improved hand-held video game controllers that advance the art.

### SUMMARY OF THE INVENTION

The present invention is directed to a computer game controller comprising a hand-held casing, a plurality of control buttons logistically positioned within the casing for manipulation by a user for producing a plurality of game control signals, and at least one trackball input device integrally mounted to the casing for manipulation by the user for producing a game input signal. A communication cable connects the controller with a stand-alone computer game device. The cable establishes a communication link to facilitate the transmission of command signals. The video game controller of the present invention provides two-way interaction with the stand-alone computer device. Alternatively, the video game controller may be a wireless controller

The hand-held video game controller according to a first exemplary embodiment of the present invention, incorporates two integrated trackball control devices: a first trackball control device and a second trackball control device, and a joystick input device. The video game controller further includes first and second sensitivity switches incorporated into the casing to selectively control the sensitivity of the first and second trackball control devices.

The hand-held video game controller according to a second exemplary embodiment of the present invention, incorporates a trackball control device, and right and left joystick input devices. The video game controller further includes a sensitivity switch incorporated into the casing to selectively control the sensitivity of the trackball control device, and a trackball mode switch that allows the trackball input device to function either as a directional pad, the right joystick input device or the left joystick input device.

The hand-held video game controller according to a third exemplary embodiment of the present invention, incorporates a trackball control device, a directional pad (D-pad) and right and left joystick input devices. The video game controller further includes a sensitivity switch incorporated into the casing to selectively control the sensitivity of the trackball control device, and a trackball mode switch that allows the trackball input device to function either as a directional pad, the right joystick input device or the left joystick input device.

Therefore, the hand-held video game controller in accordance with the present invention represents a novel arrangement of the video game controller that integrates a trackball input device into the hand held game controller for controlling variables in an application. Sensitively of the trackball input device may be controlled in addition to selectively choosing which conventional input member the trackball input device will replace. The video game controller with integrated trackball input device thus provides for superior control of application variables as well as the ability for users to customize the control and operation of applications to meet their personal needs.

### BRIEF DESCRIPTION OF THE DRAWINGS

FIG. 1A is a top plan view of a conventional video game controller of the prior art;

FIG. 1B is a bottom plan view of the conventional video game controller of the prior art;

FIG. 2A is a top plan view of a video game controller according to a first exemplary embodiment of the present invention;

FIG. 2B is a front view of the video game controller according to the first exemplary embodiment of the present invention;

FIG. 2C is a left side view of the video game controller according to the first exemplary embodiment of the present invention;

FIG. 3 is a schematic diagram of an electronic circuitry of the video game controller according to the first exemplary embodiment of the present invention;

FIG. 4A is a partially exposed top view of the video game controller according to the first exemplary embodiment of the present invention;

FIG. 4B is a partially exposed rear view of the video game controller according to the first exemplary embodiment of the present invention;

FIG. 5A is a sectional view as seen from the plane indicated by the line A-A in FIG. 4A;

FIG. 5B is a sectional view as seen from the plane indicated by the line B-B in FIG. 4A;

FIG. 6A is a top plan view of a video game controller according to a second exemplary embodiment of the present invention;

FIG. 6B is a front view of the video game controller according to the second exemplary embodiment of the present invention;

FIG. 6C is a left side view of the video game controller according to the second exemplary embodiment of the present invention;

FIG. 7A is a top plan view of a video game controller according to a third exemplary embodiment of the present invention;

FIG. 7B is a front view of the video game controller according to the third exemplary embodiment of the present invention;

FIG. 7C is a left side view of the video game controller according to the third exemplary embodiment of the present invention.

### DETAILED DESCRIPTION OF THE PREFERRED EMBODIMENTS

The preferred embodiments of a present invention will now be described with the reference to accompanying drawings. For purposes of the following description, certain terminology is used in the following description for convenience only and is not limiting. The words “right”, “left”, “bottom” and “top” designate directions in the drawings to which reference is made. The words “inwardly” and “outwardly” refer to directions toward and away from, respectively, the geometric center of the present invention and designated parts thereof. However, it is to be understood that the invention may assume various alternative orientations, except where expressly specified to the contrary. The terminology includes the words specifically mentioned above, derivatives thereof and words of similar import.

It is also to be understood that the specific article illustrated in the attached drawings, and described in the following specification is simply exemplary embodiment of the inventive concept. Specific dimensions and other physical characteristics relating to the embodiment disclosed herein are not to be considered as limiting, unless expressly stated otherwise. Additionally, the word “a,” as used in the claims, means “at least one.”

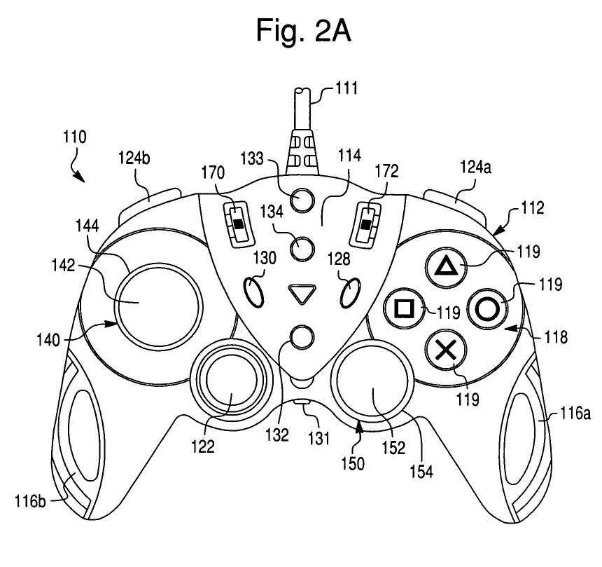

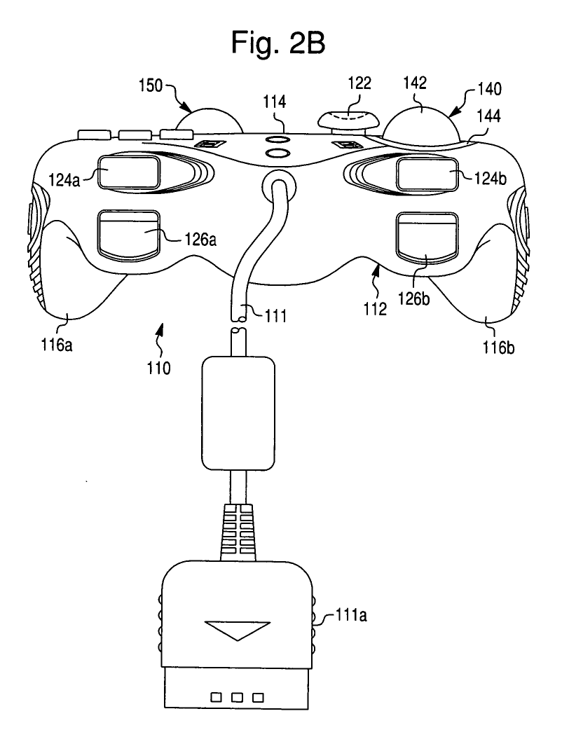

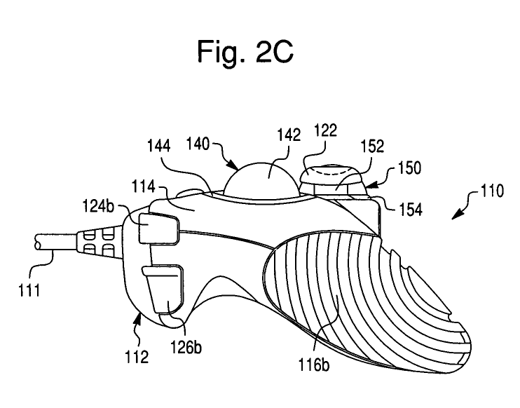

FIGS. 2A-2C, 3, 4A, 4B, 5A and 5B depict a hand-held video game controller 110 according to a first exemplary embodiment of the present invention. A video game controller 110 is ergonomically formed to be held by a hand(s) of a user. The video game controller 110 includes a plurality of operating members for manipulation of the users hand to facilitate interaction with game play. The controller may be of the programmable type and may include a vibratory member for heightened game play as well as lighted buttons etc. A communication cable 111 is provided to transmit operation commands to a stand-alone computer gaming unit, or a game console, (not shown) in response to manipulation of said operation members by the user. Located at the terminal end of the communication cable 111 is a plug 111a. The plug 111a is used to connect the communication cable 111 to the computer gaming unit. The plug 111a has a series of electrical connections that correspond to an electrical connection within a receptacle of the computer gaming unit. Alternatively, the video game controller 110 may be a wireless controller includes a radio frequency or infrared transmitter for sending control signals to the game console, wherein the game console includes a receiver for receiving the control signals from the game controller.

The computer gaming unit typically includes a disc drive mechanism in which a disc, such as a compact disc, has stored thereon a video game program, and a conventional circuitry for executing the video game program stored on disc. For example, the gaming unit may include a processor, memory and stored system programs for controlling the operation of the gaming unit, controller interface circuitry, and audio/video generating and outputting circuitry. An example of suitable computer gaming units are the Nintendo N64™, SEGA Genesis, X-Box, Gamecube, Sony Playstation game systems, etc. The hand-held video game controller 10 according to this embodiment of the present invention is connected to the gaming unit via a direct wire link in the form of the communication cable 111. Further, a wireless control unit can be connected to the gaming unit by, for example, a direct wire link or by mating connectors.

As illustrated in FIGS. 2A-2C, the game controller 110 includes a hollow casing 112 defining a central control section 114, and left and right hand grip sections 116a and 116b extending out from the control section 114. Thus, the game controller 110 is intended to be utilized by both hands of a user. The user grasps the respective left and right hand grip sections 116a and 116b with each hand, the user's thumbs remaining extended over the central control section 114. Typically, a player grips the left and right handgrip sections 116a and 116b during play and operates control switches corresponding to the handgrip sections gripped.

The control section 114 includes a plurality of operating members, which the user will utilize to enter data and control signals. Those operating members, which are disposed on the control section 114, are intended to be individually operated by one or both thumbs of the user.

A button pad 118 provided with a plurality of user activated buttons (or switches) 119 are mounted to the control section 114 of the casing 112 and accessible from an outer peripheral surface of the casing 112. The game controller 110 also includes a battery (not shown) that supplies power to the internal components of the controller.

The game controller 110 is further provided with a joystick input device 122 on the left side of the control section 114 of the casing 112, and trigger switches (shoulder buttons) 124a, 124b and 126a, 126b. The joystick input device 122 is a directional control device usually used as an input device for two or three dimensional movement of an object controlled by the game controller 110, while the trigger switches 124a, 124b, 126a and 126b can be used for performing at least one control function associated with the object. Typically, the trigger switches are used to fire weapons during a game.

Video game controllers have various buttons to implement several modes of operation within the game controller 110. The video game controller 110 and the computer gaming unit contain circuitry and drivers to effectuate the commands given from the user to the computer gaming unit via the video game controller 110. For example, a “START” button 128 is used to start a video game once the computer gaming unit is turned on. Usually an opening screen appears to the operator on a display device. Another example of a button with specific functions is a “SELECT” button 130. The SELECT button 130 allows the user to scroll through the various options presented by the computer gaming unit. A “TURBO” button 132 allows the user to select a “TURBO” mode for a particular function. It is often desirable to have a particular function at an accelerated speed or provide an additional power boost to the action on the display. Also, the user will effectuate a program mode through activation of a “PROGRAM” button 134.

The video game controller 110 also includes a frequency response unit in the form of conventional vibration device that is well known in the art. Such device includes activation of a rotating eccentric weight and is commonly known to those skilled in the art. The video game controller 110 of the present invention includes a 3-position vibration switch 131 to selectively turn off the vibrating member or select between low and high vibration modes.

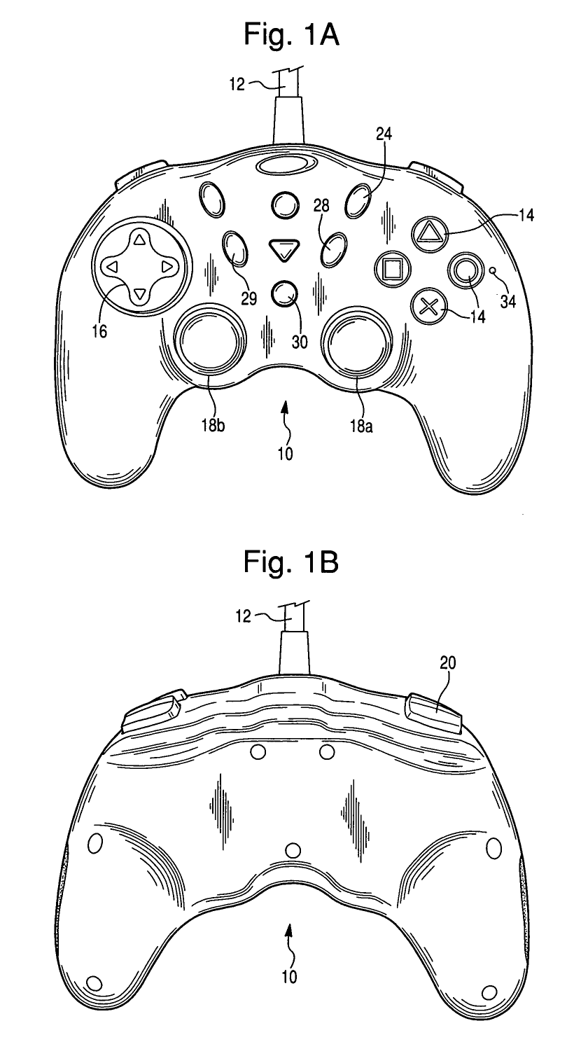

Furthermore, the game controller 110 in accordance with the first exemplary embodiment of the present invention incorporates two integrated trackball control devices: a first trackball control device 140 and a second trackball control device 150. It will be appreciated by comparing FIG. 2A with FIG. 1A that the first trackball control device 140 replaces the D-pad 16 of the video game controller 10 of the prior art, while the second trackball control device 150 replaces the joystick input device 18b of the game controller of the prior art. Preferably, the first and second trackball control devices 140 and 150 are substantially similar and may be in the form of any appropriate off-the-shelf trackball mechanism commonly known to those skilled in the art. As an example, the trackball control devices 140 and 150 may be similar to the trackball mechanisms of the mechanical-type disclosed in U.S. Pat. Nos. 5,410,332, 5,171,978, 5,162,780, 5,078,019, 4,933,670, 4,575,086, 4,505,165 and 4,404,865 incorporated herein by reference. Preferably, according to the present invention, the first and second trackball control devices 140 and 150 are optical-type trackball devices including a trackball and associated optical elements, well known in the prior art as may be seen by reference to the U.S. Pat. Nos. 6,586,720, 6,552,716, 6,124,587, 6,084,574, 5,854,482 and 5,680,157 the disclosures of which are incorporated herein by reference. The optical-type trackball devices are well known in the art and could be found in a number of applications, such as, for example, laptops for cursor control and mouse devices.

Conventionally, the trackball devices are used as a position information input device (pointing device) for inputting position information for moving a cursor on the display screen of an information processing apparatus such as a computer. To make the operation space unnecessary, a trackball device includes a spherical body, e.g., a ball, which is rotatably supported in a ball holder so as to expose a part of its outer circumferential portion to the outside, and a circuit for converting the rotation amount of this spherical body into an electrical signal. The trackball is rotatable in any direction independent of the ball holder. The amount obtained by rotating the exposed portion of the spherical body when operated with a finger of the user is converted into the electrical signal. In response to this signal, position information is input to a control unit of an information processing apparatus, such as a computer.

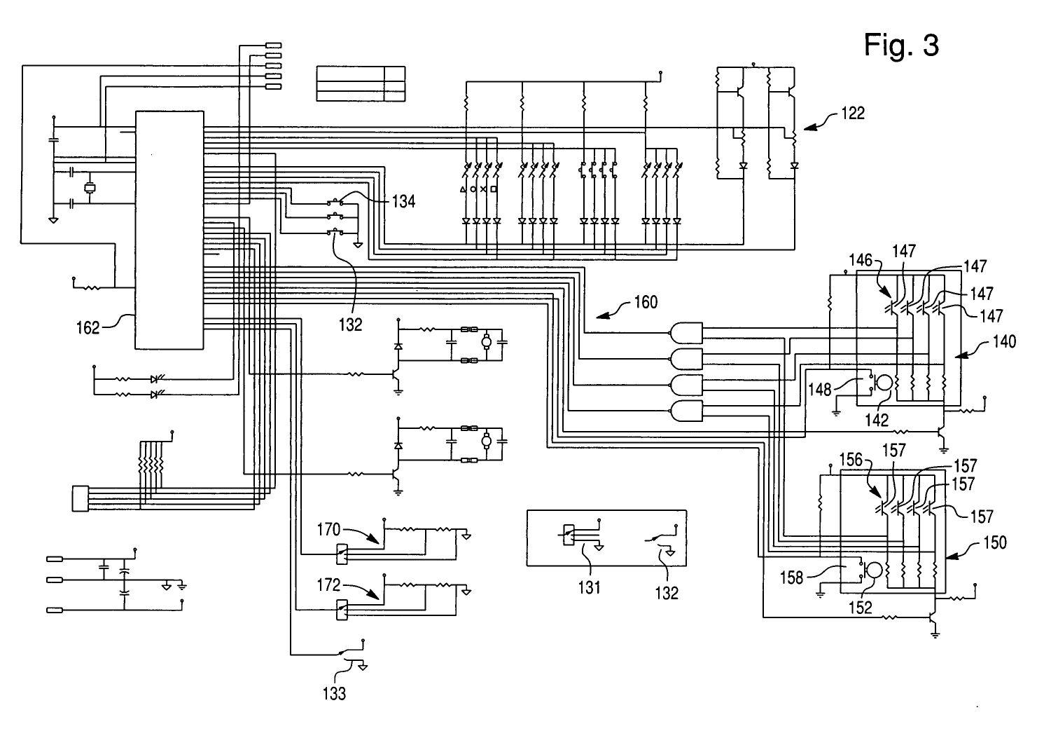

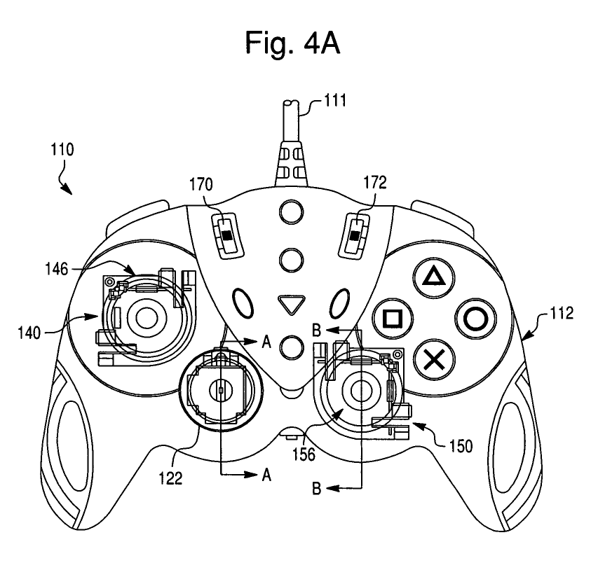

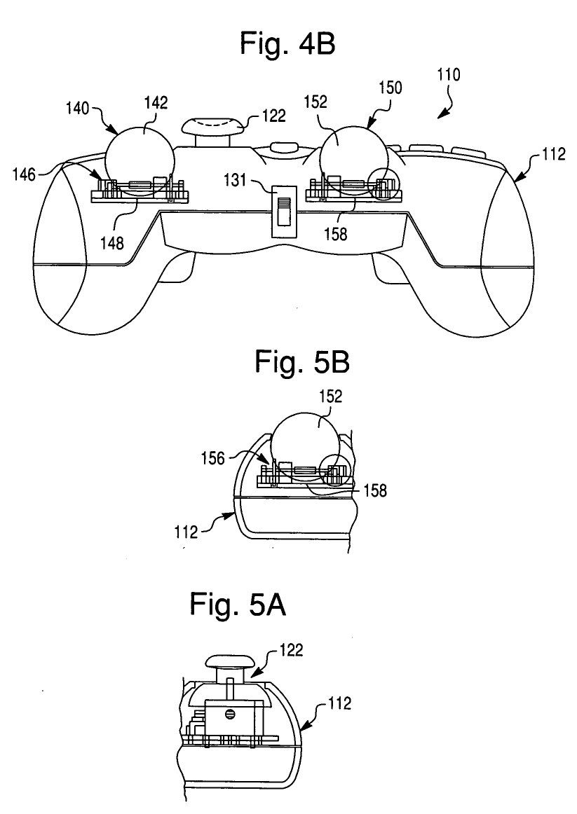

Referring to FIGS. 2A-2C and 3, the first trackball control device 140 is the optical-type trackball device and includes a first trackball 142 mounted within a first ball holder 144 for rotation relative to the casing 112 about orthogonal axes, first trackball rotational position sensors 146, and a first selector switch 148 (shown in FIGS. 3 and 4B) activated when the first trackball 142 is pressed. In this particular embodiment the first trackball 142 is a spherical ball with a substantially smooth exterior. As shown in FIGS. 2A-2C, the first ball holder 144 is integrally mounted in a recess in the control section 114 of the casing 112 so that the first trackball 142 partially extends out thereof.

In this embodiment, as illustrated in FIG. 3 depicting an electronic circuitry 160 of the video game controller 110 according to the first exemplary embodiment of the present invention, the first trackball control device 140 includes an associated array of first optical (photosensitive) elements 147 forming two rotational position sensors 146 oriented orthogonally to each other. However, in alternate embodiments more or less than two rotational position sensors could be provided and they could be orientated at any suitable orientation relative to each other. The optical elements 146 are electrically connected to an electronic control unit (ECU) 162 of the electronic circuitry 160, such as a microprocessor.

Thus, the first trackball control device 140 is provided to generate a signal indicative to the amount and direction of rotational movement of the first trackball 142 relative to the casing 112 in each of the orthogonal directions.

The second trackball control device 150 is generally identical to the first trackball control device 140 as disclosed hereinabove, and includes a second trackball 152 mounted within a second ball holder 154 for rotation relative to the casing 112 about the orthogonal axes, second trackball rotational position sensors 156, and a second selector switch 158 (shown in FIG. 3) activated when the second trackball 152 is pressed. As shown in FIGS. 2A-2C, the second ball holder 154 is integrally mounted in a recess in the control section 114 of the casing 112 so that the second trackball 152 partially extends out thereof. As further illustrated in FIG. 3, the second trackball control device 150 includes an associated array of second optical (photosensitive) elements 157 forming two rotational position sensors 156 oriented orthogonally to each other.

Preferably, the second trackball control device 150 is smaller, than the first trackball control device 140. More preferably, the first trackball 142 is 22 mm in diameter, while the second trackball 152 is 20 mm in diameter. Similarly to the first trackball control device 140, the second trackball control device 150 is, preferably, the optical-type trackball device and includes an associated array of optical (photosensitive) elements 156 forming two rotational position sensors oriented orthogonal to each other. The optical elements 156 are electrically connected to the ECU 162 of the electronic circuitry 160. Thus, the second trackball control device 150 is provided to generate a signal indicative to the amount and direction of rotational movement of the second trackball 152 relative to the casing 112 in each of the orthogonal directions.

FIGS. 4A-5B represent additional partially exposed and sectional views of the first exemplary embodiment of FIGS. 2A-2C and 3. In this embodiment, each of the first and second trackball control devices 140 and 150 incorporates the selector switch 148 and 158, respectively, in the form of a micro-switch for enhanced operation of the trackball control device. As illustrated in FIGS. 4B and 5B, each of the trackballs 142 and 152 floats in a housing of a spring biased support member. Pressing down on the trackball will cause the trackball to move. The micro-switch, either first or second selector switches 148 and 158, in the form of a make/break contact switch, is positioned underneath the trackball. When the trackball is depresses hard enough, overcoming the spring bias, the contact is made. This switch closes a circuitry to the ECU (micro-controller) 162. Thus micro-controller 162 recognizes whether the trackball has been depressed or remains suspended for rotational control. When the switch is made, the micro-controller continues to send control command signals to the gaming unit using the last known direction and velocity sensed by the controller. Thus the user may employ the trackball control device for a variable that lends itself to continuous fire such as a firing device or controlling the movement of the variable such as a racecar or other moving object. For example, when the user wishes for a game object to continuously move in a particular direction, the user simply moves the trackball until the object moves in the desired direction at the desired speed. Then, when such direction and speed are achieved, the user simply depresses the track ball, the micro-controller will continuously sense the command signals to maintain directional and speed control. The user simply releases the track ball when a change in direction or speed is desired.

The video game controller 110 further has an ON/OFF switch 133 shown in FIG. 2A. In OFF state of the switch 133, the joystick input device 122 on the left and the second trackball control device 150 on the right function as they are. However, when the switch 133 is in ON state, the left joystick input device 122 and the right trackball control device 150 are swapped. In other words, in ON state, the left joystick input device 122 generates the control signal usually generated by the right trackball control device 150 (when the switch 133 is in OFF state), while the right trackball control device 150 generates the control signal usually generated by the left joystick input device 122.

The integration of the trackball control devices 140 and 150 into the hand-held video game controller 110 provides superior control of a variable signal and is particularly suited for aiming (directional) and force control, for example golfing video games such as Tiger Woods golf on the Playstation II platform as well as other gaming software.

The existing off-the-shelve trackball control devices, for example those found in laptops for cursor control and mouse devices, produce the control signal that is difficult to control and maneuver is some applications. Moreover, different applications may require different sensitivity for controlling the variable signal in the application. Furthermore, personal preferences of the user as well as skill level require different sensitivity for optimal control by a specific user.

Thus, a mechanism to selectively control the sensitivity of the trackball control devices 140 and 150 has been incorporated into the hand held video game controller 110. As shown in FIG. 2A, the video game controller 110 further includes first and second sensitivity switches 170 and 172, respectively, incorporated into the casing 112 to selectively control the sensitivity of the first and second trackball control devices 140 and 150, respectively.

Each of the sensitivity switches 170 and 172 is slidable between at least three different positions H-high, M-medium and L-low sensitivity of an output of the trackball control devices 140 and 150 for precise motion control in the video game. As illustrated in the schematic diagram of the electronic circuitry 162 in FIG. 3, each of the sensitivity switches 170 and 172 simply moves between a plurality of different positions, either infinitely variable, or between discrete positions. The sensitivity switch 170, 172 makes or brakes contacts in a different manner to vary the resistance between the sensitivity switch 170, 172 and the ECU 162. Thus the voltage drop across the variable resistance will change as will the resultant current. The ECU 162 senses the different conditions and the internal software is programmed to manipulate input (control) signals from the trackball control device 140, 150 differently according to the selected position of the sensitivity switch 170, 172. The specific algorithm to selectively control the trackball control device 140, 150 in response to different sensed conditions (sensitivity switch position) is not essential to the present invention and may be derived and implemented by one of ordinary skill in the art.

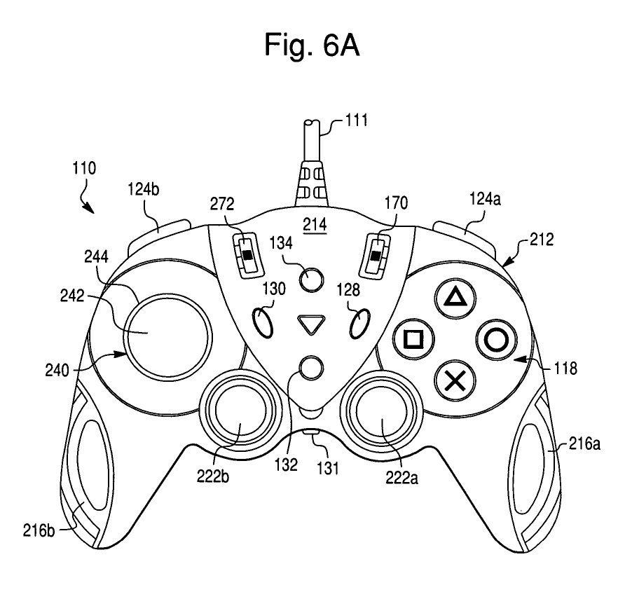

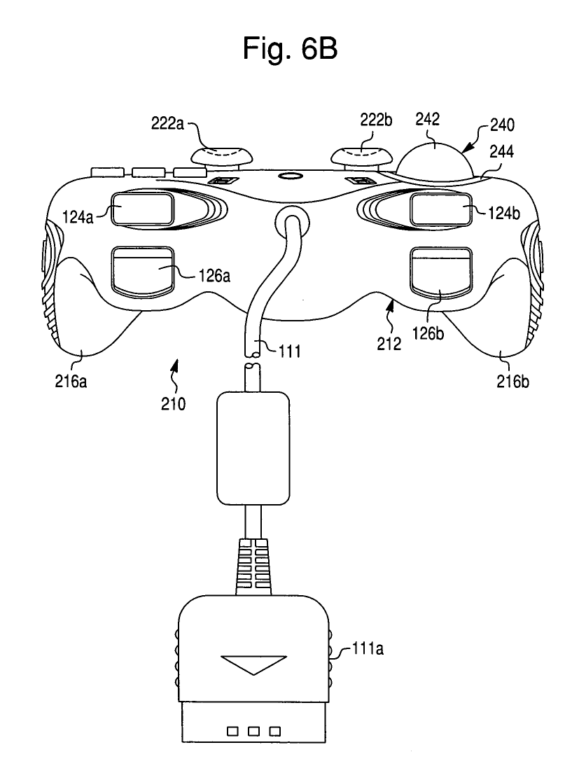

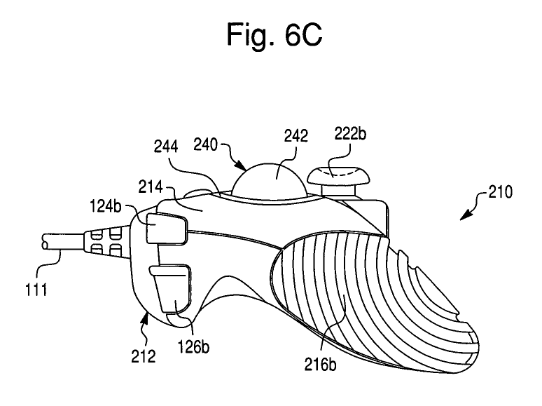

FIGS. 6A-6C of the drawings illustrate a second exemplary embodiment of a hand-held video game controller according to the present invention. Components, which are unchanged from, or function in the same way as in the first exemplary embodiment depicted in FIGS. 2A-2C and 3 are labeled with the same reference numerals, sometimes without describing detail since similarities between the corresponding parts in the two embodiments will be readily perceived by the reader.

A hand-held video game controller 210 of the second exemplary embodiment includes a hollow casing 212 defining a central control section 214, and left and right hand grip sections 216a and 216b extending out from the control section 214. A button pad 118 provided with a plurality of user activated buttons (or switches) is mounted to the control section 214 of the casing 212 and accessible from an outer peripheral surface of the casing 212.

The game controller 210 is further provided with right (first) and left (second) joystick input devices 222a and 222b, and trigger switches (shoulder buttons) 124a, 124b and 126a, 126b. The right and left joystick input devices 222a and 222b are directional control devices used as input devices for two or three dimensional movement of an object controlled by the game controller 210, while the trigger switches 124a, 124b, 126a and 126b can be used for performing at least one control function associated with the object. Typically, the trigger switches are used to fire weapons during a game.

Moreover, the game controller 210 in accordance with the second exemplary embodiment of the present invention incorporates a trackball input device 240 that replaces the conventional D-pad 16 of the video game controller 10 of the prior art, shown in FIG. 1A. The trackball input device 240 is substantially identical to the trackball input devices 140 and 150 according to the first exemplary embodiment of the present invention. As shown in FIG. 6A, the video game controller 210 further includes a sensitivity switch 170 incorporated into the casing 212 to selectively control the sensitivity of the trackball control device 240.

The game controller 210 also includes a trackball mode switch 272 that provides the game controller 210 with the ability to selectively control which conventional control member, (i.e. the D-pad 16, the right and left joystick input devices 18a and 18b shown in FIG. 1A) the trackball input device 240 will replace. The trackball mode switch 272 is slidable between at least three different positions D-D-pad, L-left joystick input device and R-right joystick input device. In other words, the trackball mode switch 272 may provide for the trackball input device 240 to take over for the conventionally known D-pad when in position D. When in position L, the trackball input device 240 will then control operation of the variable conventionally associated with the first (left) joystick input device 222b, and in position R, the second (right) joystick input devices 222a. Here again, the switch 272 is selectively positioned to alter the resistance between the switch and an ECU of the game controller 210. Thus, the ECU easily recognizes which mode of operation is selected and utilizes the input of trackball signals to control the operation otherwise associated with the conventional input devices of the prior art. Such increase of programmability allows the user to customize the control of gaming variables to personal likenesses.

Many software applications are developed for use with the conventional game controller 10 shown in FIG. 1A. For example, some games will associate certain controlled variables with the D-pad 16, the left joystick input device 18b or right joystick input device 18a. Thus, the game controller 210 of the present invention will allow the user to selectively control which conventional input device the trackball input device 240 will govern.

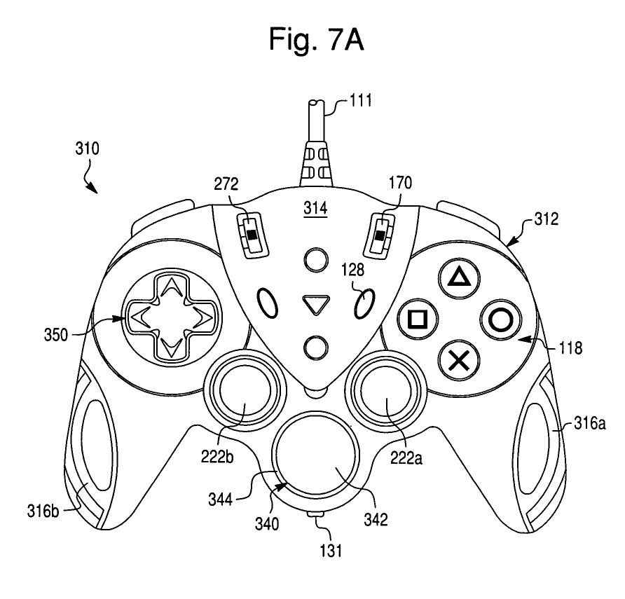

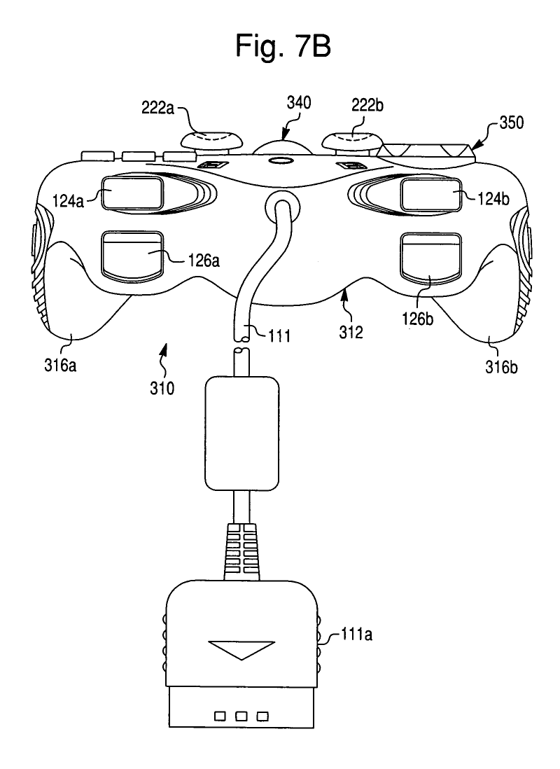

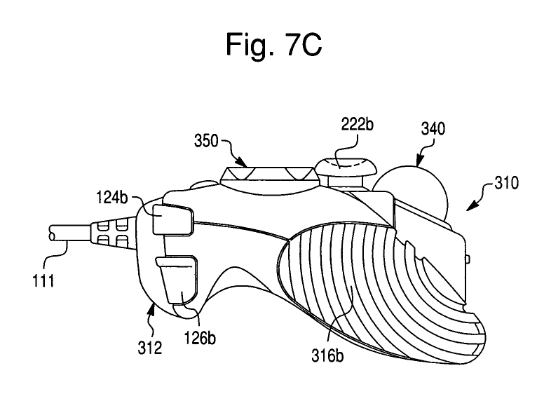

FIGS. 7A-7C of the drawings illustrate a third exemplary embodiment of a hand-held video game controller according to the present invention. Components, which are unchanged from, or function in the same way as in the first exemplary embodiment depicted in FIGS. 2A-2C, 3 and 6A-6C are labeled with the same reference numerals, sometimes without describing detail since similarities between the corresponding parts in the two embodiments will be readily perceived by the reader.

A hand-held video game controller 310 of the third exemplary embodiment includes a hollow casing 312 defining a central control section 314, and right and left hand grip sections 316a and 316b extending out from the control section 314. A button pad 118 provided with a plurality of user activated buttons (or switches) is mounted to the control section 314 of the casing 312 and accessible from an outer peripheral surface of the casing 312. The game controller 310 is further provided with right and left joystick input devices 222a and 222b, a D-pad 350 as a directional control device and trigger switches (shoulder buttons) 124a, 124b and 126a, 126b. The right and left joystick input devices 222a and 222b are directional control devices used as input devices for two or three dimensional movement of an object controlled by the game controller 210, while the trigger switches 124a, 124b, 126a and 126b can be used for performing at least one control function associated with the object. Typically, the trigger switches are used to fire weapons during a game.

Moreover, the game controller 310 in accordance with the third exemplary embodiment of the present invention incorporates a trackball input device 340 centrally located on the control section 314 of the casing 312. The trackball input device 340 may be operated by the thumb of either a right hand or left hand of the user. The trackball input device 340 is substantially identical to the trackball input device 240 according to the second exemplary embodiment of the present invention.

As shown in FIG. 7A, the video game controller 310 further includes a sensitivity switch 170 incorporated into the casing 312 to selectively control the sensitivity of the trackball control device 340. The game controller 310 also includes a trackball mode switch 372 that provides the game controller 310 with the ability to selectively take over the control of any of the conventional control members (the D-pad 350, the right joystick input device 222a or the left joystick input device 222b). The trackball mode switch 372 is slidable between at least three different positions D-D-pad, L-left joystick input device and R-right joystick input device. When in position D, the trackball input device 340 overrides and replaces the D-pad 350.

When in position L, the trackball input device 240 will replace the first (left) joystick input device 222b, and in position R, the second (right) joystick input devices 222a. Here again, the switch 272 is selectively positioned to alter the resistance between the switch and an ECU of the game controller 210.

Therefore, the hand-held video game controller in accordance with the present invention represents a novel arrangement of the video game controller that integrates a trackball input device into the hand held game controller for controlling variables in an application. Sensitively of the trackball input device may be controlled in addition to selectively choosing which conventional input member the trackball input device will replace. The video game controller with integrated trackball input device thus provides for superior control of application variables as well as the ability for users to customize the control and operation of applications to meet their personal needs.

The description of the preferred embodiments of the present invention has been presented for the purpose of illustration in accordance with the provisions of the Patent Statutes. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

1. A hand-held video game controller for interaction with a computer gaming unit, said controller comprising:
a hand-held casing; and
a plurality of operating members logistically positioned in said casing for manipulation by a user for producing a plurality of game control signals;
one of said plurality of said operating members includes at least one trackball input device integrally mounted to said casing for manipulation by the user.

2. The hand-held video game controller according to claim 1, further comprising at least one sensitivity switch to selectively control a sensitivity of said at least one trackball input device.

3. The hand-held video game controller according to claim 2, wherein said at least one sensitivity switch is incorporated into said casing.

4. The hand-held video game controller according to claim 2, wherein said at least one sensitivity switch controls the sensitivity of said at least one trackball input device by selectively varying an electric current between said at least one trackball input device and an electronic control unit of said video game controller.

5. The hand-held video game controller according to claim 2, wherein said at least one sensitivity switch includes a variable resistor for selectively varying an electric resistance between said at least one trackball input device and an electronic control unit of said video game controller.

6. The hand-held video game controller according to claim 1, wherein said at least one trackball input device is mounted in a recess in a top surface of said hand-held casing.

7. The hand-held video game controller according to claim 1, wherein said casing defines a control section; and wherein said plurality of operating members are mounted on said control section of said casing.

8. The hand-held video game controller according to claim 7, wherein said at least one trackball input device includes a ball holder mounted on said control section of said casing, a substantially spherical trackball freely rotatable within said ball holder in any direction relative to said casing and a mechanism for sensing the amount and direction of rotational movement of said trackball relative to said casing in each of orthogonal directions, said trackball input device generating a signal indicative to the amount and direction of rotational movement of said trackball relative to said casing in each of orthogonal directions.

9. The hand-held video game controller according to claim 1, wherein said plurality of operating members further comprises at least one directional control device for manipulation by one of a right hand of the user and a left hand thereof.

10. The hand-held video game controller according to claim 9, further comprising a trackball mode switch allowing said at least one trackball input device to selectively override and replace said at least one directional control device.

11. The hand-held video game controller according to claim 9, wherein said at least one directional control device includes a directional pad.

12. The hand-held video game controller according to claim 9, wherein said at least one directional control device includes a joystick input device.

13. The video game controller according to claim 9, further comprising a switch adapted to switch control parameters generated by said at least one trackball input device and said a at least one directional control device.

14. The hand-held video game controller according to claim 1, wherein said at least one directional control device comprises at least one first operating member for manipulation by a right hand of the user and at least one second operating member operated by a left hand of the user.

15. The hand-held video game controller according to claim 14, further comprising a trackball mode switch allowing said at least one trackball input device to selectively override and replace any one of said at least one first and second operating members.

16. The hand-held video game controller according to claim 15, wherein said trackball mode switch allows said trackball input device to operate as one of a directional pad, said at least one first operating member and said at least one second operating member.

17. The hand-held video game controller according to claim 15, wherein each of said at least one first operating member includes a first joystick input device and said second operating member includes a second joystick input device.

18. The hand-held video game controller according to claim 17, wherein said trackball mode switch allowing said at least one trackball input device to selectively override and replace one of said first joystick input device and said second joystick input device.

19. The hand-held video game controller according to claim 17, wherein said at least one second operating member further includes a directional pad.

20. The hand-held video game controller according to claim 19, wherein said trackball mode switch allowing said at least one trackball input device to selectively override and replace one of said directional pad, said first joystick input device and said second joystick input device.

21. The video game controller according to claim 1, wherein said at least one trackball input device includes a first trackball input device and a second trackball input device.

22. The video game controller according to claim 21, wherein said first trackball input device is provided for manipulation by a left hand of the user and said second trackball input device is provided for manipulation by a right hand of the user.

23. The video game controller according to claim 21, further comprising a first sensitivity switch to selectively control a sensitivity of said first trackball input device and a second sensitivity switch to selectively control a sensitivity of said second trackball input device.

24. The video game controller according to claim 23, wherein both said first and second sensitivity switches are incorporated into said casing.

25. The video game controller according to claim 14, further comprising a switch adapted to switch control parameters generated by said at least one trackball input device and one of said at least one first operating member and said at least one second operating member.

26. The video game controller according to claim 1, further comprising at least one communication cable operatively connected to said hand-held casing and provided to transmit said game input and control signals to the computer gaming unit in response to manipulation of said plurality of buttons and said at least one trackball input device by the user.

27. The video game controller according to claim 21, further comprising a joystick input device mounted to said casing for manipulation by the user for producing said game control signal.

28. The video game controller according to claim 27, further comprising a switch adapted to switch control parameters generated by said second trackball input device and id joystick input device.

29. The video game controller according to claim 1, further comprising first and second joystick input devices and a directional pad all mounted to said casing for manipulation by the user for producing said game input signal.

30. The video game controller according to claim 29, further comprising a trackball mode switch allowing said at least one trackball input device to replace one of said directional pad, said first joystick input device and said second joystick input device.

31. The hand-held video game controller according to claim 1, wherein said at least one trackball input device is provided for manipulation by a left hand of the user.

32. The hand-held video game controller according to claim 1, wherein said at least one trackball input device is provided for manipulation by a right hand of the user.

33. The hand-held video game controller according to claim 1, wherein said at least one trackball input device is provided for manipulation by any one of left and right hands of the user.
